(19) United States
(12) Patent Application Publication
(10) Pub. No.: US 2022/0399853 A1
(43) Pub. Date: Dec. 15, 2022

(54) SOLAR PANEL CARRIAGE

(71) Applicant: Solar Pivot Power, Wabasha, MN (US)

(72) Inventors: Dale Hanks, Wabasha, MN (US); Uttam Singh, Austin, TX (US); Dan Moravec, Wabasha, MN (US)

(21) Appl. No.: 17/841,355

(22) Filed: Jun. 15, 2022

Related U.S. Application Data
(60) Provisional application No. 63/210,745, filed on Jun. 15, 2021.

(51) Int. Cl. H02S 30/10; H02S 30/20

(52) U.S. Cl. CPC H02S 30/10; H02S 30/20

(57) ABSTRACT

A solar panel carriage is disclosed. The solar panel carriage may include a cross-piece, a pivot shaft connected to the cross piece, a center hinging mechanism connected to the cross-piece, one or more arms extending outwardly from the cross-piece and connected to the cross piece the center hinging mechanism, a flange disposed at an end of the one or more arms, and, a knobbed bolt configured to be inserted through the flange, and through a first side of a solar panel, and threaded into the flange on a second side of the solar panel. The one or more arms of the solar panel carriage may be configured to fold into a position parallel to the cross-piece via a movement of the center hinging mechanism.

### PRIORITY CLAIM

The present application claims the benefit of priority of U.S. Provisional Patent Application Ser. No. 63/210,745, titled “Adaptive Solar Tracking System and Portable Mechanical Solar Tracker,” filed Jun. 15, 2021, which is incorporated herein by reference.

### BACKGROUND

Portable solar panels may provide a way to convert solar energy into usable electrical power for various electrical devices. Solar panels may be configured to collect solar energy by setting the solar panel up on a stationary stand, placing the solar panel flat on the ground, mounting the solar panel to a structure, securing the solar panel to the body of a vehicle, or placing the solar panel in any area where it has a chance of collecting solar energy. However, a lack of rigidity in portable solar panels may make it challenging to re-mount to a solar panel carriage each time the solar panel carriage is moved. The disclosed solar panel carriage may be configured to allow foldable/rollable solar panels to retain their compactness when stored, while allowing them to be easily mounted on a rigid structure when used with a solar tracking system.

### SUMMARY

One embodiment provides a solar panel carriage comprising a cross-piece, a pivot shaft connected to the cross piece, a center hinging mechanism connected to the cross-piece, one or more arms extending outwardly from the cross-piece and connected to the cross piece via the center hinging mechanism, a flange disposed at an end of the one or more arms, and a knobbed bolt configured to be inserted through the flange, and through a first side of a solar panel, and threaded into the flange on a second side of the solar panel, wherein the one or more arms are configured to fold into a position parallel to the cross-piece via a movement of the center hinging mechanism.

A product comprising a center hinging mechanism connected to a cross-piece, one or more arms extending outwardly from the cross-piece and connected to the cross piece the center hinging mechanism, and a flange disposed at an end of the one or more arms, wherein the one or more arms are configured to fold into a position parallel to the cross-piece via a movement of the center hinging mechanism.

Other aspects of the disclosure will become apparent by consideration of the detailed description and accompanying drawings.

### BRIEF DESCRIPTION OF THE DRAWINGS

FIG. 1 shows an underside view of an adjustable solar panel carriage fully extended in an open configuration.

FIG. 2 shows the adjustable solar panel carriage fully extended in the open configuration with a solar panel attached,

FIG. 3 shows a side view of the fully extended adjustable solar panel carriage and solar panel of FIG. 2.

FIG. 4 shows the adjustable solar panel carriage in a closed configuration without an attached solar panel.

FIG. 5 shows the closed adjustable solar panel carriage and solar panel of FIG. 4.

FIG. 6 shows an adjustable solar panel carriage in a closed and the folded position.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical or hydraulic connections or couplings, whether direct or indirect.

Also, it is to be understood that the phraseology and terminology used herein are for the purpose of description and should not be regarded as limiting. The use of “including,” “comprising,” or “having and variations thereof” are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

A solar panel may be rigid, foldable, or flexible, and configured to collect solar energy via solar cells disposed on at least one face of the solar panel. A solar panel carriage may be constructed and arranged to support the solar panel. In some cases, the solar panel carriage is configured to attach to the solar panel (e.g., using clips or fasteners). The solar panel carriage may include a solar carriage mounting feature configured to accommodate mounting the solar carriage on a roof, a wall, a floor, a stand, a pole, etc. The solar panel carriage may be constructed of metal (e.g., lightweight aluminum), polymer (e.g., carbon fiber, ABS plastic), ceramic (e.g., electrical ceramic), wood, or any other material capable of supporting a solar panel while it collects solar energy. A solar panel carriage may be constructed of a plurality of components assembled together (e.g., using fasteners, snap fits, glues, welds, etc.). Often times, solar panel carriages are large and rigid, and are therefore relatively difficult to store and transport. A portable, adjustable, folding solar panel carriage is disclosed.

The amount of solar energy harvested by a solar panel may in some cases be maximized by positioning a solar cell face of the solar panel in clear sight of the sun, with a solar cell face of the solar panel oriented at an angle perpendicular to the location of the sun, such that the angle of incidence is very low (e.g., 0° to 15°). As the sun moves, however, the strategically placed solar panel may begin to generate less energy than it would if properly positioned to maintain a low angle of incidence to light emitted by the sun. Solar tracking systems of various types may be used to overcome this problem by moving a solar panel along the path of the sun to maintain a low angle of incidence between light emitted by the sun and a solar cell face of the solar panel. The disclosed solar panel carriage provides a means by which a portable solar panel may be attached to a rigid structure that may be in turn mounted to a solar tracker.

The disclosed solar panel carriage also provides an attachment mechanism which enables a portable solar panel to be connected to a solar tracking system, utilizing the reinforced steel grommets present on the portable solar panels (e.g., embedded in a plurality of positions near the perimeter of the solar panel structure). These steel grommets may be used for hanging a solar panel, for example, from the side of a camper vehicle. The disclosed solar panel carriage also causes forces from wind and weight to be distributed across the solar panel carriage, rather than the solar panel alone. The arms of the disclosed solar panel carriage may extend and retract to fit portable solar panels of various sizes. The solar panel carriage may be configured to fold with a foldable solar panel attached, facilitating increased portability and storage for both the combined solar panel and solar panel carriage when compared with conventional solar panel carriages. Further, the solar panel carriage, once detached from a portable solar panel, may be configured to fold up into a small form factor for longer term storage.

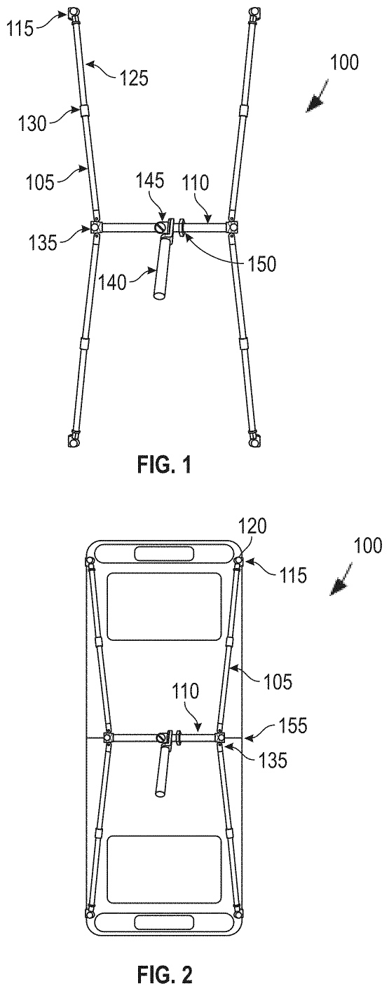

FIG. 1 shows an overview of a solar panel carriage 100 comprising four arms 105 configured to connect to and support a solar panel (not shown) and a cross-piece 110 which connects the four arms 105 together. The solar panel carriage is shown fully deployed in an open configuration. A flange 115 may be configured to provide an attachment point where the solar panel (not shown) connects to the solar panel carriage 100. A knobbed bolt 120 may be inserted through the flange 115 and into a reinforced steel grommet (not shown) of a solar panel and tightened into an embedded nut (not shown) on the backside of the flange 115. In this way, a solar panel may be mounted to the arms 105 of the solar panel carriage 100. Tube 125 may be configured to extend and retract in order to accommodate panels of various widths and lengths. A locking mechanism 130, such as a twist-lock or knob, which may be disposed at and end of the tube 125, may be tightened to keep the arm 105 at a fixed length. A center hinging mechanism 134, configured to be tightened or loosened by central hinge knob 135 (e.g., configured to be prevented from hinging or freed to hinge in response to the tightening or loosening of the central hinge knob 135), may provide a structural core for a folding and locking function of the solar panel carriage (shown in FIG. 4) by enabling rotation of the arms 105 in the longitudinal, rotational and transverse directions. The center hinging mechanism 134 may be configured to hinge such that the arms 105 may be raised and lowered, and further configured to turn such that the arms 105 may be rotated. In this way, the solar panel carriage 100 may be fully deployed in the open configuration, half deployed in the closed configuration or folded for storage. In the embodiment shown, the central hinge knob 135 in a first position, restricts the movement of the arms 105 to only frontal rotation. The first position for the central hinge knob 135 may be perpendicular to the cross-piece 110. Once the solar panel is connected to the flange 115 on each arm 105, the arms 105 may lock into place and the pivot shaft 140 may be used to mount the solar panel carriage 100 an external stand or device such as a solar tracking system (not shown). The pivot shaft 140 may be configured to allow a user to tilt the solar panel carriage 100 to a desirable angle, even when a solar panel is mounted to the solar panel carriage 100. For example, a user may tilt the pivot shaft 140 a 90-degree angle perpendicular to the horizon and the rest of solar panel carriage 100 may rotate along point 145 while locked in place by tightening knob 150.

FIG. 2 shows the solar panel carriage 100 in the open configuration with a solar panel 160 attached. The flange 115 may be used to engage the solar panel 160 at all four corners in the manner described above. In the embodiment shown, midline 155 is a folding point of the attached solar panel 160. As will be shown and discussed in FIGS. 4-6, the solar panel carriage 100 may be configured to fold with the solar panel 160 attached, enabling easy portability. In the embodiment shown, in order to fold the solar panel carriage 100 in half, the central hinge knob 135 on both sides of the cross-piece 110 are loosened and the center hinging mechanisms 134 rotated into a position parallel with the cross-piece 110. Two of the four arms 105 are then moved in the longitudinal direction until the solar panel carriage 100 with attached portable solar panel is folded in half.

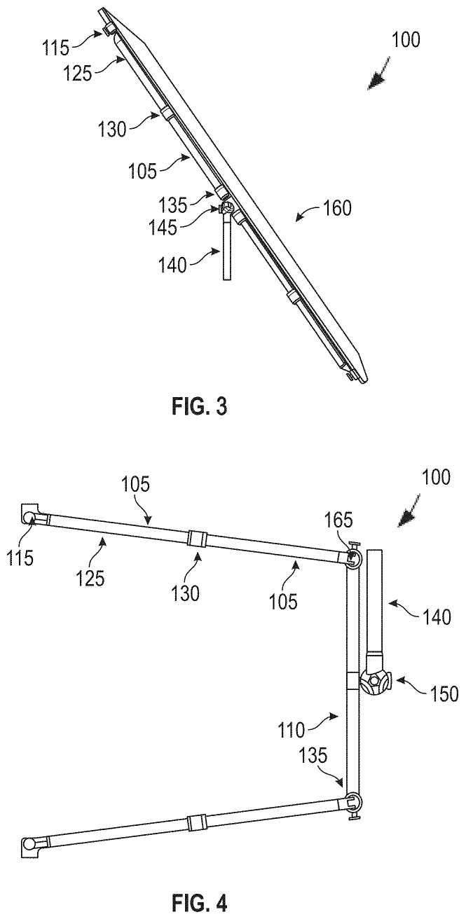

FIG. 3 shows a side view of the solar panel carriage 100 in the open configuration with a solar panel 160 attached. All other features are as described in FIGS. 1-3.

FIG. 4 shows a bottom view of the solar panel carriage 100 in a semi-closed configuration without an attached solar panel 160. The arms 105 have been folded from an outward to inward, parallel to a horizontal plane defined by the cross-piece 110 toward one another. The central hinge knob 135 on both sides of the cross-piece 110 has been loosened and rotated to be parallel with the cross-piece 110. The solar panel carriage 100 is then folded in half by moving two of the arms 105 in a longitudinal direction, perpendicularly to the horizontal plane defined by the cross-piece 110. In the embodiment shown, the pivot shaft 140 is shown rotated inward toward the cross-piece 110.

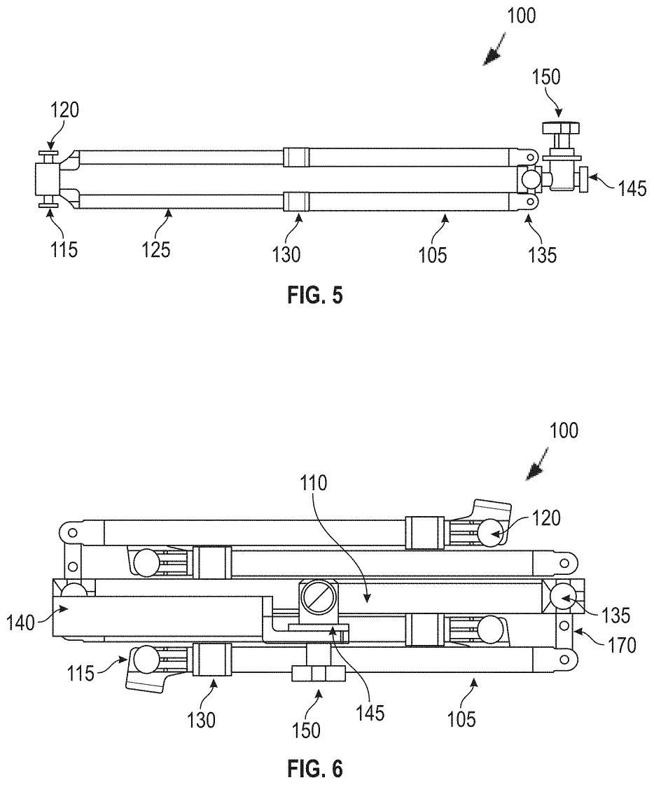

FIG. 5 shows a side view of the solar panel carriage 100 without an attached solar panel 160, A portable solar panel 160 which folds may remain attached and fold together with the solar panel carriage 100, In the embodiment shown, the arms 105 have been folded in the longitudinal direction, as described above, such that the arms 105 are parallel to each other.

FIG. 6 shows the solar panel carriage 100 in the fully folded configuration. In the embodiment shown, the procedure to place the solar panel carriage 100 in the fully folded configuration starts by loosening the central hinge knob 135 and extending a slider 170 connected between two of the arms 105 and the cross-piece 110. The twist-lock locking mechanism 130 is loosened and the tube 125 is fully retracted into the arm 105. The arms 105 are then rotated inwardly, parallel to the cross-piece 110, by turning the center hinging mechanisms 134 and the sliders 170 inward on both sides of the cross-piece 110 so that the arms 105 interleave one another. Knob 150 is loosened and the pivot shaft 140 is folded down parallel to the folded arms 105.

Although certain aspects have been described in detail with reference to certain preferred embodiments, variations and modifications exist within the scope and spirit of one or more independent aspects as described.

What is claimed is:

1. A solar panel carriage comprising:
a cross-piece;
a pivot shaft connected to the cross piece;
a center hinging mechanism connected to the cross-piece;
one or more arms extending outwardly from the cross-piece and connected to the cross piece via the center hinging mechanism;
a flange disposed at an end of the one or more arms; and,
a knobbed bolt configured to be inserted through the flange, and through a first side of a solar panel, and threaded into the flange on a second side of the solar panel,
wherein the one or more arms are configured to fold into a position parallel to the cross-piece via a movement of the center hinging mechanism.

2. The solar panel carriage of claim 1; wherein the center hinging mechanism is configured to be prevented from hinging by a tightening of a hinge knob.

3. The solar panel carriage of claim 1, wherein center hinging mechanism is configured to hinge such that the one or more arms are raised and lowered with respect to the cross-piece.

4. The solar panel carriage of claim 3, wherein the center hinging mechanism is further configured to turn such that the one or more arms are rotated.

5. The solar panel carriage of claim 1, wherein the arm includes a tube configured to be extended from the one or more arms to increase a length of the one or more arms.

6. The solar panel carriage of claim 5, wherein the one or more arms further include locking mechanism configured to be twisted to lock the tube from extending.

7. The solar panel carriage of claim 1, wherein the pivot shaft is connected to be mounted to a base.

8. The solar panel carriage of claim 1, wherein at least one of the one or more arms includes a slider connecting the at least one arm of the one or more arms to the cross-piece.

9. The solar panel carriage of claim 1, wherein the one or more arms are made of polymer.

10. A product comprising:
a center hinging mechanism connected to a cross-piece;
one or more arms extending outwardly from the cross-piece and connected to the cross piece via the center hinging mechanism; and,
a flange disposed at an end of the one or more arms,
wherein the one or more arms are configured to fold into a position parallel to the cross-piece via a movement of the center hinging mechanism.

11. The product of claim 10, wherein the center hinging mechanism is configured to be prevented from hinging by a tightening of a hinge knob.

12. The product of claim 10, wherein center hinging mechanism is configured to hinge such that the one or more arms are raised and lowered with respect to the cross-piece.

13. The product of claim 12, wherein the center hinging mechanism is further configured to turn such that the one or more arms are rotated.

14. The product of claim 10, wherein the arm includes a tube configured to be extended from the one or more arms to increase a length of the one or more arms.

15. The product of claim 14, wherein the one or more arms further include a locking mechanism configured to be twisted to lock the tube from extending.

16. The product of claim 10, wherein the pivot shaft is connected to be mounted to a base.

17. The product of claim 10, wherein at least one of the one or more arms includes a slider connecting the at least one arm of the one or more arms to the cross-piece.

18. The solar panel carriage of claim 10, wherein the one or more arms are made of polymer.
